(19) United States
(12) Patent Application Publication
(10) Pub. No.: US 2022/0342389 A1
(43) Pub. Date: Oct. 27, 2022

(54) SYSTEM FOR CONTROLLING A VEHICLE CONVEYOR, AND A VEHICLE WASH HAVING THE SAME

(71) Applicant: Stephenson Technologies Inc., Barrie (CA)

(72) Inventor: Robert Roy STEPHENSON, Barrie (CA)

(21) Appl. No.: 17/302,204

(22) Filed: Apr. 27, 2021

(51) Int. Cl. G05B 19/4155; B60S 3/00; B60S 3/04

(52) U.S. Cl. CPC G05B 19/4155; B60S 3/004; B60S 3/04; G05B 2219/50393

(57) ABSTRACT

A system for controlling a vehicle conveyor and a vehicle wash having the same are provided. The system includes an array of beam transmitters, each being positionable to transmit a beam towards a vehicle path through which a vehicle is expected to travel. Each of at least one sensor is positionable to receive the beam from at least one of the array of beam transmitters when the beam is unobstructed and generate sensor data. A storage stores computer-executable instructions. A controller in communication with the storage and connected to the at least one sensor, when executing the computer-executable instructions, controls operation of the vehicle conveyor at least partially based on the sensor data.

### FIELD

The specification relates generally to conveyors, and in particular to a system for controlling a vehicle conveyor, and a vehicle wash having the same.

### BACKGROUND OF THE DISCLOSURE

Vehicle conveyor systems for vehicle washes and the like are known. The vehicle conveyor systems can employ chain drives, endless belts, rollers, or any other suitable means for conveying a vehicle along a vehicle path. For example, in a vehicle wash, the vehicle path can be a path along which are positioned a series of exterior washing and/or treatment apparatuses.

It is desirable to position the vehicles closer to one another in order to increase the number of vehicles serviced. The resulting reduced spacing between the vehicles, however, increases the risk of contact between vehicles at a dismounting end of the vehicle conveyor.

In order to have a vehicle conveyed by a vehicle conveyor, the vehicle is positioned at a location towards a mounting end where the vehicle conveyor can engage and commence to move the vehicle. Engagement between the vehicle conveyor and the vehicle can be through a moving surface positioned under at least one of the wheels of the vehicle or some other means.

Once the vehicle is on the vehicle conveyor, the vehicle is typically moved at the same speed as other vehicles being simultaneously moved by the vehicle conveyor.

When a vehicle has been moved along the vehicle path from the engagement end to the dismounting end of the vehicle conveyor, the vehicle is typically moved to a position at which the vehicle conveyor is no longer able to move the vehicle along the vehicle path. Where, for example, the vehicle conveyor includes one or more endless belts that move a vehicle via friction between the one or more endless belts and the wheels of the vehicle, once the leading (typically, front) wheels of the vehicle are positioned on a surface forward of the dismounting end of the vehicle conveyor and the trailing (typically, rear) wheels of the vehicle are sufficiently positioned on the surface and off of the vehicle conveyor, friction between the one or more endless belts and the trailing wheels of the vehicle is insufficient to drive the vehicle further forward. The driver of the vehicle is then directed to operate the vehicle to move it further forward and away from the vehicle conveyor to make space for a subsequently moved vehicle to safely approach the dismounting end of the vehicle conveyor. If the vehicle is not moved sufficiently clear of the dismounting end of the vehicle conveyor, there is a risk that a subsequent vehicle being moved can collide with the vehicle no longer being moved.

In order to address this issue, one or more sensor plates can be deployed below a travel surface of the vehicle conveyor to detect the presence of a vehicle via the metallic components of the vehicle. These sensors generally lack an ability to identify a position of the vehicle and can only determine when a vehicle is positioned within the vicinity of the sensor plate(s).

### SUMMARY OF THE DISCLOSURE

In one aspect, there is provided a system for controlling a vehicle conveyor, comprising: an array of beam transmitters, each of the array of beam transmitters being positionable to transmit a beam towards a vehicle path through which a vehicle is expected to travel; at least one sensor, each of the at least one sensor being positionable to receive the beam from at least one of the array of beam transmitters when the beam is unobstructed and generate sensor data; a storage storing computer-executable instructions; and a controller in communication with the storage and connected to the at least one sensor, the controller, when executing the computer-executable instructions, being configured to control operation of the vehicle conveyor at least partially based on the sensor data.

The at least one sensor can include an array of sensors, each of the array of sensors being aligned to receive a transmitted beam from a corresponding one of the array of beam transmitters with which the sensor and the corresponding one of the array of beam transmitters forms a transmitter-sensor pair.

The array of beam transmitters and the array of sensors can be arranged along at least one first lateral structure and at least one second lateral structure, the at least one first lateral structure and the at least one second lateral structure being positionable along lateral sides of the vehicle path.

The array of sensors and the array of beam transmitters can be positioned along pivotable members of the at least one first lateral structure and the at least one second lateral structure to enable alignment of the array of sensors and the beams from the array of beam transmitters when the at least one first lateral structure and the at least one second lateral structure are positioned along the lateral sides of the vehicle path.

The at least one first lateral structure and the at least one second lateral structure can be configured to be mounted on a horizontal surface, and the array of sensors and/or the array of beam transmitters positioned along the pivotable members of the at least one first lateral structure can be configured to be further elevated from the horizontal surface than the array of sensors and/or the array of beam transmitters positioned along the pivotable members of the at least one second lateral structure.

One of the beam transmitter and the sensor of each of the transmitter-sensor pairs can be regularly spaced along the at least one first lateral structure, and another of the beam transmitter and the sensor of each of the transmitter-sensor pairs can be regularly spaced along the at least one second lateral structure.

The sensors of each adjacent transmitter-sensor pair can be on alternating ones of the at least one first lateral structure and the at least one second lateral structure.

The controller, when executing the computer-executable instructions, can monitor the sensor data to determine a spacing between consecutive vehicles, and terminate operation of the vehicle conveyor if the spacing is lower than a threshold. The spacing between consecutive vehicles can be measured by a number of the sensors in a first continuous set of the sensors in the array that are registering a beam, the first continuous set of the sensors separating a second continuous set of the sensors in the array and a third continuous set of the sensors in the array, the second set of the sensors and the third set of the sensors detecting an absence of a beam, and the threshold can be defined as a desired minimum number of sensors between the vehicles. The controller, when executing the computer-executable instructions, can monitor the number of the sensors in the first continuous set, and terminate operation of the vehicle conveyor if the number of the sensors in the first continuous set changes by more than a threshold number of the sensors.

The controller, when executing the computer-executable instructions, can monitor the sensor data to determine a spacing between consecutive vehicles, and terminate operation of the vehicle conveyor if the spacing is lower than a threshold. The spacing between consecutive vehicles can be measured by a number of the sensors in a first continuous set of the sensors in the array that are registering a beam, the first continuous set of the sensors separating a second continuous set of the sensors in the array and a third continuous set of the sensors in the array, the second set of the sensors and the third set of the sensors detecting an absence of a beam, and the threshold can be defined as a desired minimum number of sensors between the vehicles. The controller, when executing the computer-executable instructions, can monitor the number of the sensors in the first continuous set, and terminate operation of the vehicle conveyor if the number of the sensors in the first continuous set changes by more than a threshold number of the sensors.

The beam transmitters can be optical beam transmitters.

In another aspect, there is provided a vehicle wash having a system for controlling a vehicle conveyor, comprising: a vehicle conveyor configured to move a vehicle along a vehicle path; an array of beam transmitters, each of the array of beam transmitters being positionable to transmit a beam towards the vehicle path; at least one sensor, each of the at least one sensor being positionable to receive the beam from at least one of the array of beam transmitters when the beam is unobstructed and generate sensor data; a storage storing computer-executable instructions; and a controller in communication with the storage and connected to the at least one sensor, the controller, when executing the computer-executable instructions, being configured to control operation of the vehicle conveyor at least partially based on the sensor data.

The at least one sensor can include an array of sensors, each of the array of sensors being aligned to receive a transmitted beam from a corresponding one of the array of beam transmitters with which the sensor and the corresponding one of the array of beam transmitters forms a transmitter-sensor pair. The array of beam transmitters and the array of sensors can be arranged along at least one first lateral structure and at least one second lateral structure, the at least one first lateral structure and the at least one second lateral structure being positionable along lateral sides of the vehicle path. The array of sensors and the array of beam transmitters can be positioned along pivotable members of the at least one first lateral structure and the at least one second lateral structure to enable alignment of the array of sensors and the beams from the array of beam transmitters when the at least one first lateral structure and the at least one second lateral structure are positioned along the lateral sides of the vehicle path. The at least one first lateral structure and the at least one second lateral structure can be configured to be mounted on a horizontal surface, and the array of sensors and/or the array of beam transmitters positioned along the pivotable members of the at least one first lateral structure can be configured to be further elevated from the horizontal surface than the array of sensors and/or the array of beam transmitters positioned along the pivotable members of the at least one second lateral structure.

One of the beam transmitter and the sensor of each of the transmitter-sensor pairs can be regularly spaced along the at least one first lateral structure, and another of the beam transmitter and the sensor of each of the transmitter-sensor pairs can be regularly spaced along the at least one second lateral structure.

The sensors of each adjacent transmitter-sensor pair can be on alternating ones of the at least one first lateral structure and the at least one second lateral structure.

The controller, when executing the computer-executable instructions, can monitor the sensor data to determine a spacing between consecutive vehicles, and terminate operation of the vehicle conveyor if the spacing is lower than a threshold. The spacing between consecutive vehicles can be measured by a number of the sensors in a first continuous set of the sensors in the array that are registering a beam, the first continuous set of the sensors separating a second continuous set of the sensors in the array and a third continuous set of the sensors in the array, the second set of the sensors and the third set of the sensors detecting an absence of a beam, and the threshold can be defined as a desired minimum number of sensors between the vehicles. The controller, when executing the computer-executable instructions, can monitor the number of the sensors in the first continuous set, and terminate operation of the vehicle conveyor if the number of the sensors in the first continuous set changes by more than a threshold number of the sensors.

The controller, when executing the computer-executable instructions, can monitor the sensor data to determine a spacing between consecutive vehicles, and terminate operation of the vehicle conveyor if the spacing is lower than a threshold.

The spacing between consecutive vehicles can be measured by a number of the sensors in a first continuous set of the sensors in the array that are registering a beam, the first continuous set of the sensors separating a second continuous set of the sensors in the array and a third continuous set of the sensors in the array, the second set of the sensors and the third set of the sensors detecting an absence of a beam, and the threshold can be defined as a desired minimum number of sensors between the vehicles.

The controller, when executing the computer-executable instructions, can monitor the number of the sensors in the first continuous set, and terminate operation of the vehicle conveyor if the number of the sensors in the first continuous set changes by more than a threshold number of the sensors.

The beam transmitters can be optical beam transmitters.

The array of beam transmitters and the at least one sensor can be positioned towards a dismounting end of the vehicle conveyor.

Other technical advantages may become readily apparent to one of ordinary skill in the art after review of the following figures and description.

### BRIEF DESCRIPTIONS OF THE DRAWINGS

For a better understanding of the embodiment(s) described herein and to show more clearly how the embodiment(s) may be carried into effect, reference will now be made, by way of example only, to the accompanying drawings in which:

FIG. 1 shows a side elevation view of a system for controlling a vehicle conveyor and its operating environment in accordance with an embodiment;

FIG. 2A is a top plan view of the vehicle conveyor and lateral beam transmitter and detector bars of the system for controlling the vehicle conveyor of FIG. 1;

FIG. 2B is an enlarged view of a region 2B of the vehicle conveyor and the lateral beam transmitter and detector bars of FIG. 2A;

FIG. 3 is an enlarged side elevation view of the region 3 of the lateral beam transmitter and detector bars of FIGS. 1 to 2B;

FIG. 4 is a rear, top perspective view of a right lateral beam transmitter and detector bar of the system for controlling a vehicle conveyor of FIGS. 1 to 3;

FIG. 5 is a right side elevation view of the right lateral beam transmitter and detector bar of FIG. 4;

FIG. 6 is a front section view of the right lateral beam transmitter and detector bar of FIG. 5 along line 6-6;

FIG. 7 is a front, top perspective view of a left lateral beam transmitter and detector bar of the system for controlling a vehicle conveyor of FIGS. 1 to 3;

FIG. 8 is a left side elevation view of the left detector bar of FIG. 5;

FIG. 9 is a rear section view of the left detector bar of FIG. 8 along line 9-9;

FIG. 10 shows beam paths between the beam transmitters and the sensors of the high mount detector structure and the low mount detector structure of FIG. 1;

FIG. 11 shows an enlarged front elevation view of the region 3 of the detector bars and drying apparatuses of FIG. 1;

FIG. 12 is a schematic diagram of a controller of the system for controlling a vehicle conveyor;

FIG. 13 is a flow chart of the method performed by the system for controlling the vehicle conveyor;

FIG. 14A shows exemplary positions of a leading vehicle and a successive vehicle when a threshold distance between the vehicles is present;

FIG. 14B shows exemplary positions of a leading vehicle and a successive vehicle when a threshold distance between the vehicles is absent; and

FIG. 15 is a top plan view of a vehicle conveyor system including a system for controlling a vehicle conveyor in accordance with another embodiment.

Unless otherwise specifically noted, articles depicted in the drawings are not necessarily drawn to scale.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description. It will also be noted that the use of the term “a” or “an” will be understood to denote “at least one” in all instances unless explicitly stated otherwise or unless it would be understood to be obvious that it must mean “one”.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

A system for controlling a vehicle conveyor and a vehicle wash having the same are disclosed herein. The system includes an array of beam transmitters and an array of sensors for receiving the beams and generating sensor data. Using the sensor data, the system determines when a distance between a leading vehicle towards a dismounting end of the vehicle conveyor and a successive vehicle is below a threshold, and terminates operation of the vehicle conveyor when this condition is met. The system enables vehicles to be spaced at a desired distance from one another whilst maintaining a minimum distance between successive vehicles to reduce the risk of contact between the vehicles.

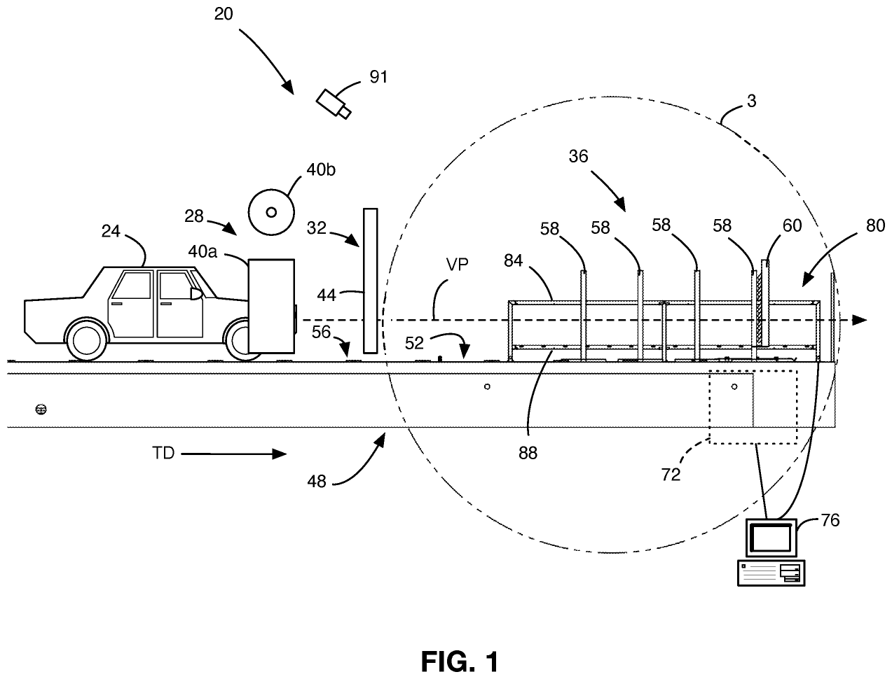

A vehicle wash 20 for a vehicle 24 in accordance with an embodiment is shown in FIG. 1. The vehicle wash 20 has a service line of vehicle wash components, including washing apparatuses 28, rinsing apparatuses 32, and drying apparatuses 36. The scale and position of the vehicle wash components in the figures has been modified for ease of illustration. The washing apparatuses 28 includes a set of position-controllable rotating wash brushes 40a, 40b that can be repositioned with at least one degree of freedom. The rinsing apparatuses 32 includes one or more rinsing bars 44 or rinsing bar structures. The rinsing bars 44 have a set of rinsing fluid outlets for spraying jets of rinsing fluid on the exterior surface of a vehicle to wash away the washing fluid remaining on the vehicle after completion of the washing stage by the washing apparatuses 28. Steel frames 58 are positioned to enable drying equipment to be mounted. A drying vent bar 60 for directing airflow at and/or over the exterior surface of a vehicle to evaporate and/or urge the rinsing fluid off of the exterior surface is shown mounted on one of the steel frames 58. As directed airflows quickly diverge over distances, the drying vent bars 60 are repositionable via one or more motors, hydraulics, or any other suitable means to maintain the drying vent bars 60 within a desired distance range of the exterior surface of the vehicle.

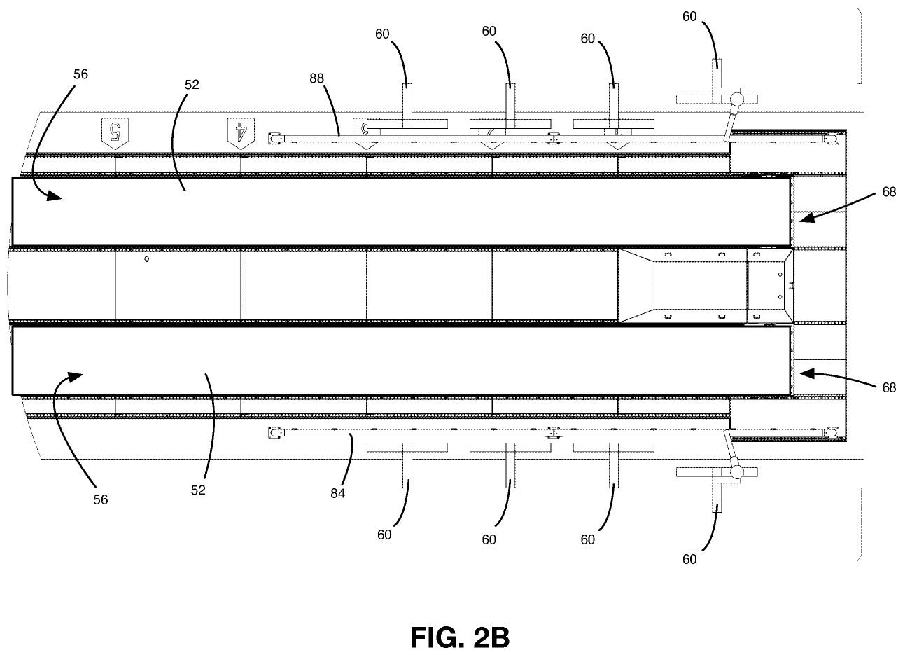

Now referring to FIGS. 1 to 3, the vehicle conveyor system 48 is configured to move the vehicle 24 along a vehicle path VP through the vehicle wash 20. The vehicle conveyor system 48 includes a vehicle conveyor that engages the vehicle 24 to translate the vehicle through the service line. The vehicle conveyor in this embodiment includes a pair of endless belts 52. The endless belts 52 extend parallel to one another, and the endless belts 52 are spaced from one another and have lateral widths to ensure that most automotive vehicle types can position their wheels on one lateral side of the vehicle 24 on one of the endless belts 52, and their wheels on the other lateral side of the vehicle 24 on the other endless belt 52. The endless belts 52 have a mounting end 64 at which vehicles mount atop of the endless belts 52, and a dismounting end 68 at which vehicles dismount from the endless belts 52. As shown, the mounting and dismounting ends 64 and 68 respectively align relative to a longitudinal axis LA of the endless belts 52.

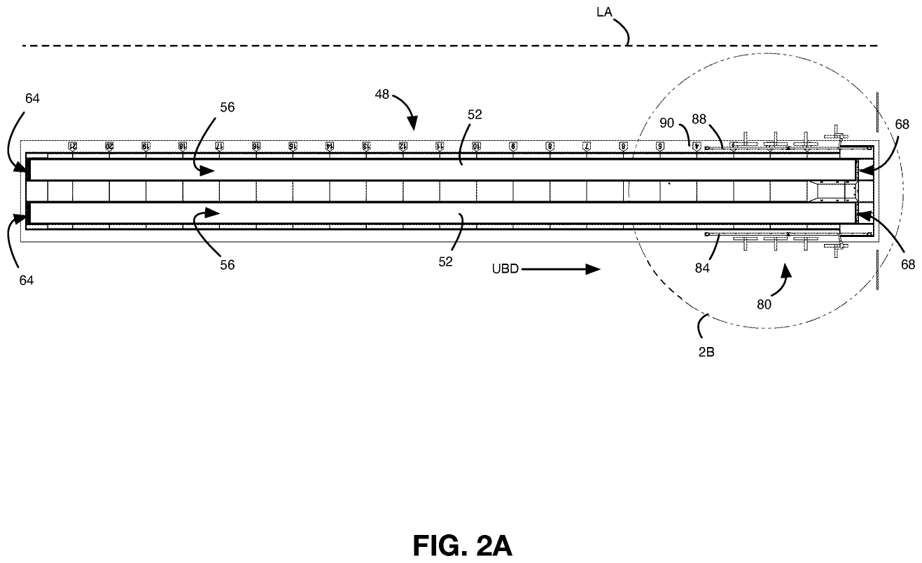

An outer surface 56 of the endless belts 52 can have wheel engagement features, such as ridges that extend transversely to an upper belt direction UBD of an upper portion of the endless belt 52 (shown in FIG. 2A) to engage the wheels of the vehicle 24 to urge the vehicle 24 along the vehicle path VP. Alternatively, the upper surface 56 of the endless belts 52 can have a relatively high coefficient of friction to frictionally engage the wheels of the vehicle 24.

In other embodiments, the vehicle conveyor can include a single endless belt for receiving the wheels on both sides of a vehicle together or the wheels of one lateral side of the vehicle while the vehicle is placed in neutral, a chain drive that securely engages one or more wheels of the vehicle while the vehicle is in neutral, a bed of driven rollers, or any other suitable means for conveying a vehicle along a path through the vehicle wash 20.

The endless belt 52 is driven by a drive unit 60 coupled to the endless belt 52. The drive unit 60 includes a drive roller driven by one or more motors. The drive roller typically has features that engage the endless belts 52 to precisely control their speed and, in some cases, direction. In other embodiments, separate drive units 60 can drive each of the endless belts 52 independently. Further, the drive unit 60 can be any arrangement to actuate the conveyor system in order to move the vehicle 24 along the vehicle path VP.

A controller 76 is connected to the vehicle conveyor system 48 and configured to control its operation. The controller 76 can be any suitable computing device that has one or more processors that execute computer-executable instructions that determine how the vehicle conveyor system 48 is to be controlled.

Also connected to the controller 76 is a vehicle sensor system 80 that is positioned towards the dismounting end 68 of the endless belts 52. The vehicle sensor system 80 includes two lateral structures in the form of a high mount detector structure 84 and a low mount detector structure 88, each of which is mounted to a horizontal mounting surface 90 that is generally level with the upper surface of the endless belts 52 along a lateral side of the vehicle conveyor; that is, the pair of endless belts 52.

A video camera 91 or other imaging device can be positioned to capture one or more images of the vehicle path VP towards the dismounting end 68 of the endless belts 52.

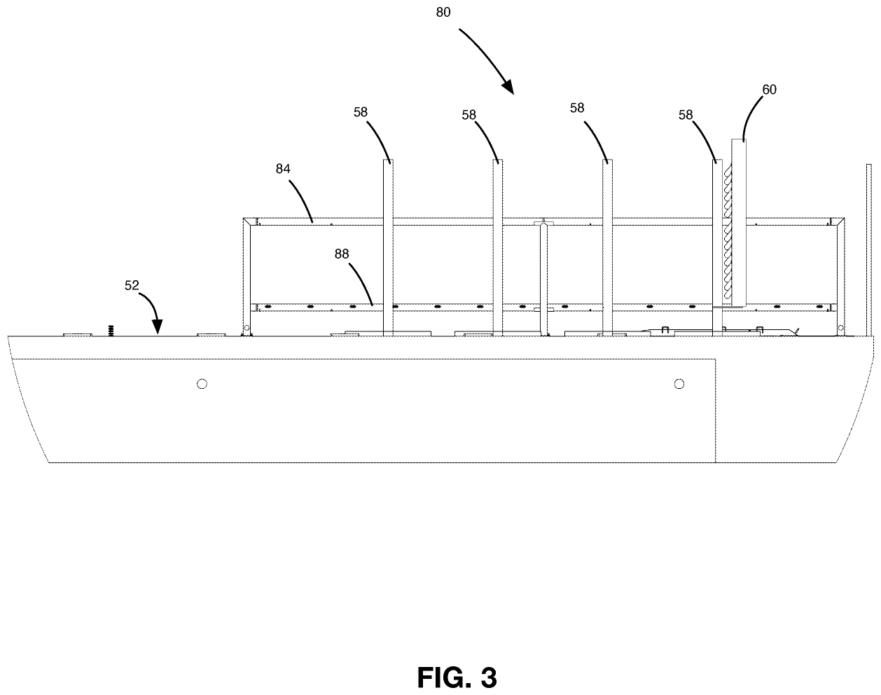

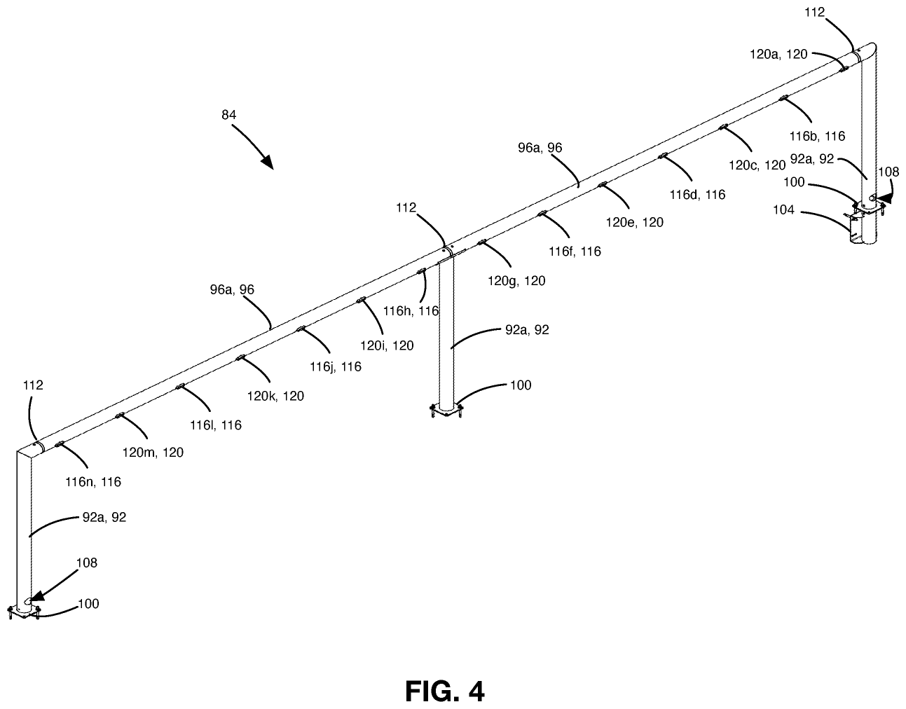

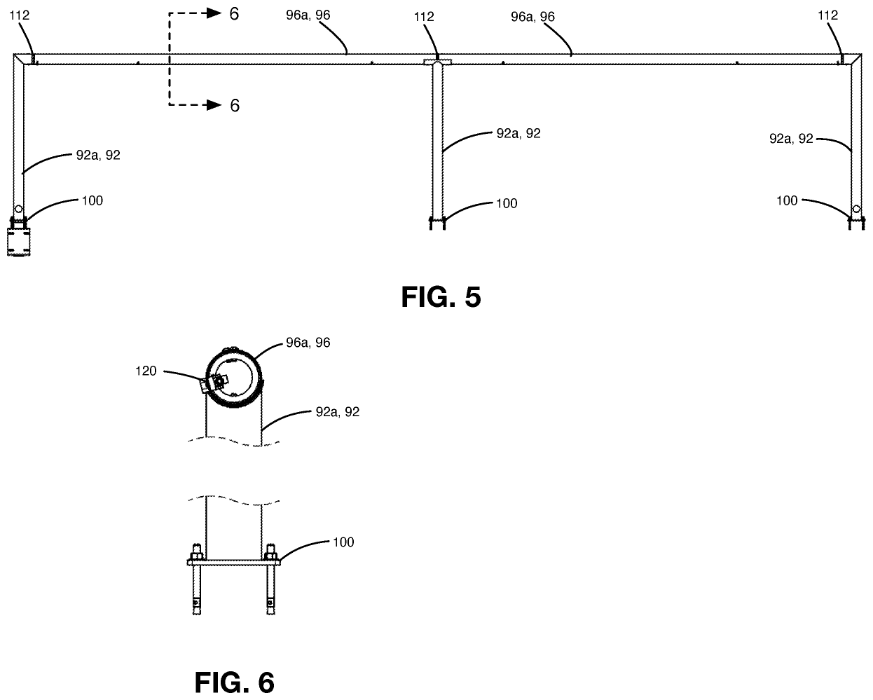

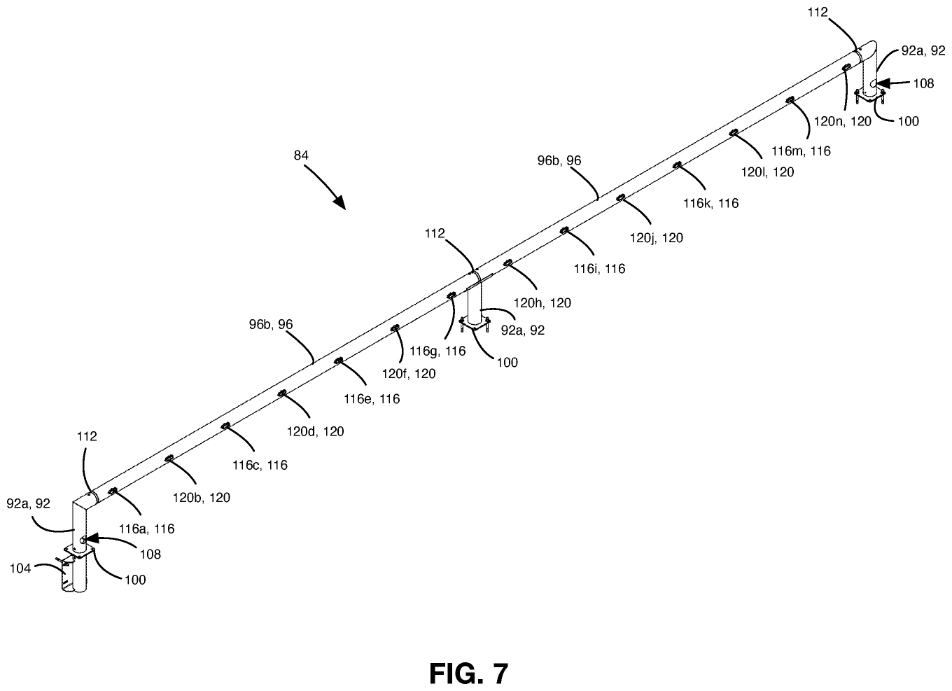

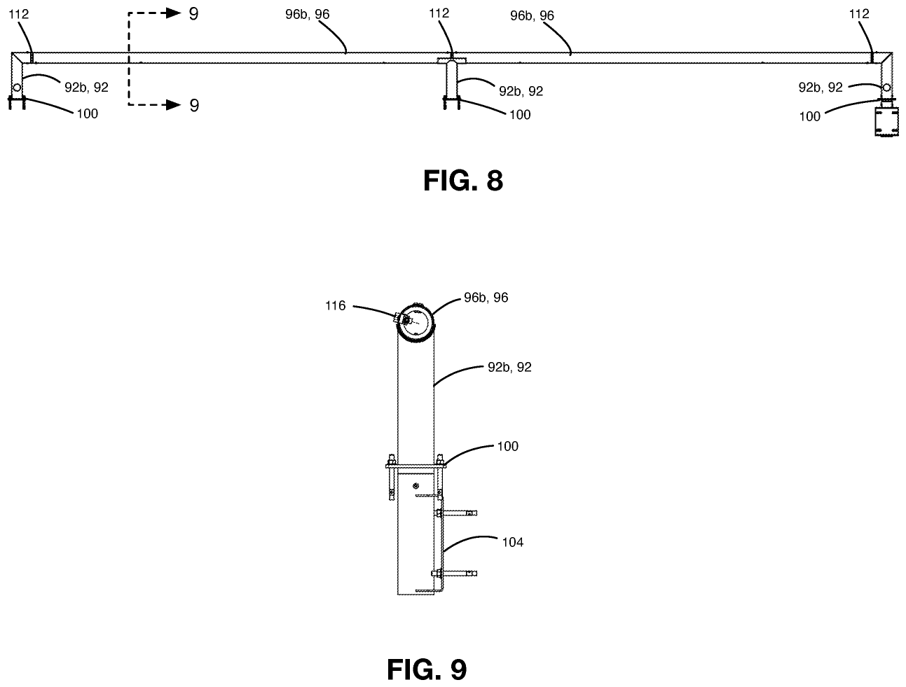

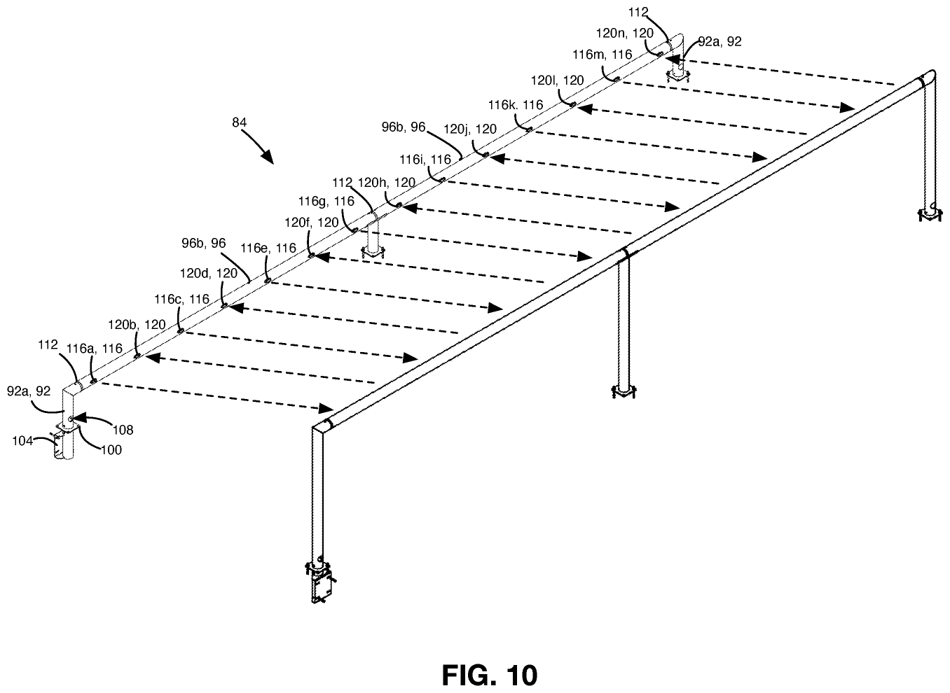

In FIGS. 4 to 6, the high mount detector structure 84 is shown having three support posts 92a supporting a detector bar 96a. The high mount detector structure 84 is shown having three support posts 92b supporting a detector bar 96b. In FIGS. 7 to 9, the low mount detector structure 88 is shown and is similar in structure and composition to the high mount detector structure 84 of FIGS. 4 to 6. The low mount detector structure 88 is shown having three support posts 92b supporting a detector bar 96b.

Now with reference to FIGS. 4 to 9, the support posts 92a, 92b (alternatively, collectively referred to hereinafter as support posts 92) and the detector bars 96a, 96b (alternatively, collectively referred to hereinafter as detector bars 96) are constructed from stainless steel tubing, but alternatively can be made of aluminum, plastic, or any other suitably rigid material that can withstand operating in damp or wet environments. Each of the support posts 92 have a horizontal mounting bracket 100 at a lower end thereof to enable mounting of the high mount detector structure 84 and the low mount detector structure 88 to the horizontal mounting surface 90. The horizontal mounting bracket 100 has fastener holes enabling fastening to the horizontal mounting surface 90 via bolts or the like in the illustrated embodiment. In addition, a vertical mounting bracket 104 enables a forward end of the high mount detector structure 84 to be secured to a vertical surface below ground level; in particular, the side wall of the pit in which much of the vehicle conveyor system 48 is positioned. While both the horizontal mounting bracket 100 and the vertical mounting bracket 104 are shown, each support post 92 can be secured via only one of the horizontal mounting bracket 100 or via a vertical mounting bracket 104. In alternative embodiments, the support posts 92 can be secured to a surface via any suitable structure. An aperture 108 in each of the end support posts 92 enables connection of power and data cables to the detector bar 96.

The detector bars 96 are pivotably connected to the support posts 92 via a set of plastic bushings 112 that enable adjustment of the angular orientation of the detector bars 96 within an angular range. This enables the lateral spacing between the high mount detector structure 84 and the low mount detector structure 88, and thus the detector bars 96, to be varied and compensated for, as the detector bars 96 can be pivoted to align the sensors 120 and the beam transmitters 116.

Along the detector bars 92 is an array of beam transmitters 116a to 116n (alternatively, collectively referred to hereinafter as beam transmitters 116) and an array of sensors 120a to 120n (alternatively, collectively referred to hereinafter as sensors 120). The beam transmitters 116 and the sensors 120 are mounted in plastic brackets that are then set into apertures of the detector bars 112.

The beam transmitters 116 in the array are lasers beam transmitters that each emit a small cone of light. The sensors 120 in the array are configured to receive and register light, and generate sensor data.

Referring again to FIGS. 4 to 9, the beam transmitters 116 and the sensors 120 are regularly spaced along the detector bars 96. In the illustrated embodiment, the beam transmitters 116 and the sensors 120 are spaced at 14 inch intervals. It will be understood that, in other embodiments, the beam transmitters 116 and the sensors 120 can be spaced at another regular interval along the detector bars 96, or can be irregularly spaced therealong.

In order to avoid having sensors 120 detect the light from beam transmitters 120 other than the corresponding one with which it is aligned, the beam transmitters 116 and the sensors 120 are alternated along each of the detector bars 96. As can be seen, beam transmitter 116a is positioned on the low mount detector structure 88 and the corresponding sensor 120a is positioned on the high mount detector structure 84. Beam transmitter 116b is positioned on the high mount detector structure 84 adjacent to sensor 120a, and the corresponding sensor 120b is positioned on the low mount detector structure 88 adjacent to beam transmitter 116a. The beam transmitters 116 and the sensors 120b continue to alternate in this manner along the high mount detector structure 84 and the low mount detector structure 88.

As a result, each sensor 120 is directly opposite a corresponding one of the beam transmitters 116 to form a transmitter-sensor pair, with the next adjacent beam transmitters 116 being two positions over; that is, 28 inches over. Thus, by staggering the beam transmitters 116 and the sensors 120, the probability of detecting light from beam transmitters 116 other than the corresponding beam transmitter 116 is reduced. In other embodiments, the beam transmitters and the sensors may not be staggered.

As shown in FIGS. 1 to 3, the array of beam transmitters 116 and the array of sensors 120 extend along the endless belts 52 towards the dismounting end 68 thereof and beyond to detect vehicles that are no longer on the endless belts 52 and that may be obstructing progress of successive vehicles. In other embodiments, the array of beam transmitters and the array of sensors can extend more or less past the dismounting end of the endless belts 52.

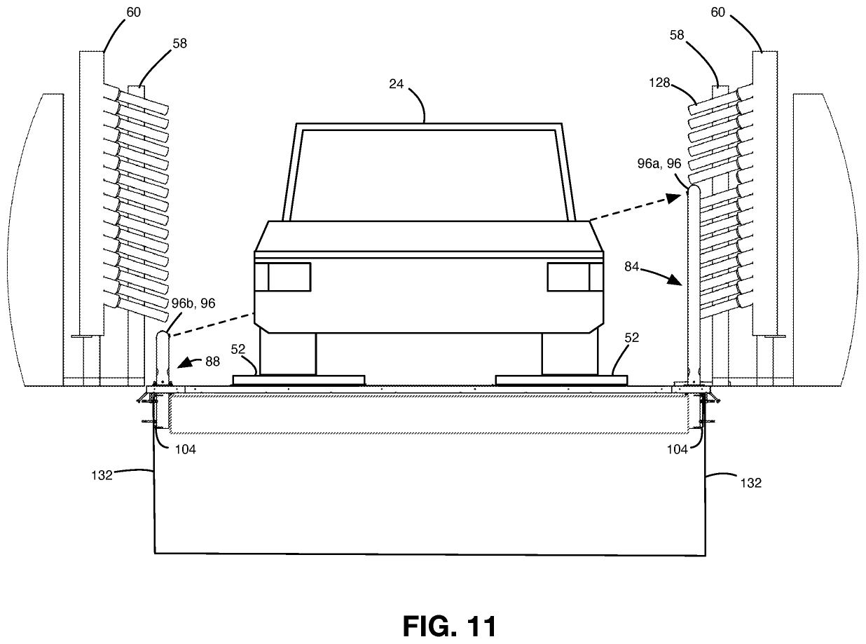

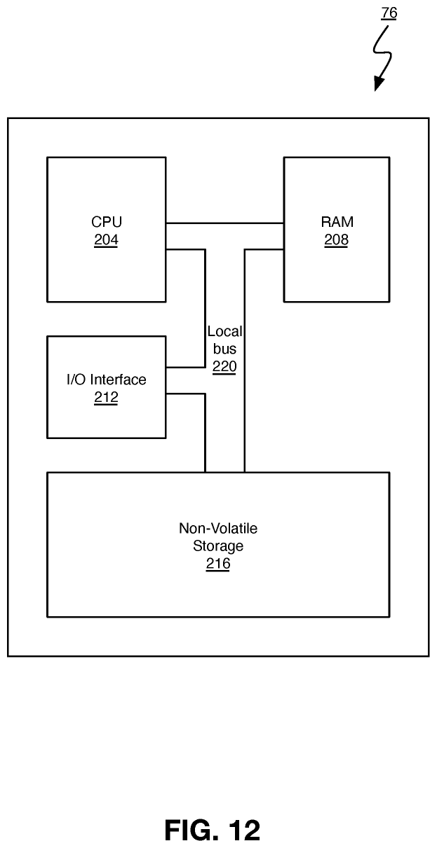

FIGS. 10 and 11 show the high mount detector structure 84 and the low mount detector structure 88 positioned relative to one another.

The support posts 92a of the high mount detector structure 84 are configured to support the crossbar 96a at a first elevation above the horizontal mounting surface 90 and the support posts 92b of the low mount detector structure 88 are configured to support the crossbar 96b at a second elevation above the horizontal mounting surface 90 that is lower than the first elevation. In the presently illustrated embodiment, the detector bar 96a of the high mount detector structure 84 is elevated at four feet above the horizontal mounting surface 90 by the support posts 92a, and the detector bar 96b of the low mount detector structure 88 is elevated at one foot above the horizontal mounting surface 90 by the support posts 92b.

In order to align the direction of the light emitted by the beam transmitters 116 with corresponding ones of the sensors 120, the detector bars 96a, 96b are rotated so that the beam transmitters 116 and the sensors 120 therealong are oriented towards and aligned with one another. When aligned, each of the sensors 120 along one of the detector bars 96 is oriented to receive the transmitted beams from a corresponding one of the beam transmitters 116 along the other of the detector bars 96. As the detector bar 96a is more elevated than the detector bar 96b, the detector bar 96a is rotated to orient the beam transmitters 116 and the sensors 120 therealong downwards. Correspondingly, the detector bar 96b is rotated upwards to orient the beam transmitters 116 and the sensors 120 therealong upwards, emit light at a downward angle and sense light from a downward position.

By transmitting beams on a diagonal, it has been found that vehicles of different heights and sizes can be detected more readily than if the beams are transmitted along a horizontal plane. As will be readily apparent, the transmitters 116 and the sensors 120 can be positioned at other elevations without substantially affecting the operation of the system.

In FIG. 11, the drying vent bars 60 have a set of vents 128 that are aligned vertically. In order to accommodate the high mount detector structure 84, one of the vents 128 is removed from the adjacent drying vent bar 60. Similar adaptations can be employed to accommodate the high mount detector bar 84 and the low mount detector bar 88 in other embodiments and environments. Here, the vertical mounting brackets 104 are secured to pit walls 132 to further stabilize the high mount and low mount detector structures 84, 88.

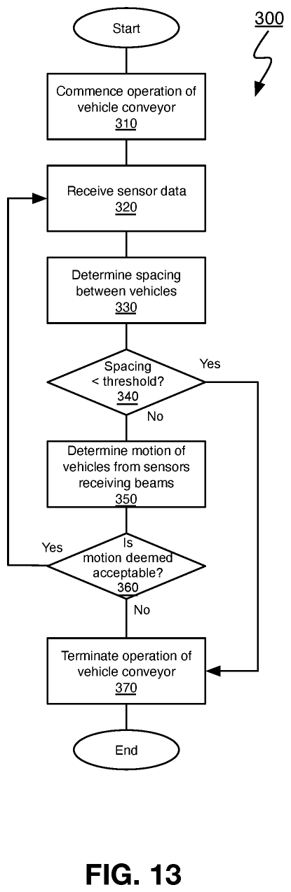

FIG. 12 shows various physical elements of the controller 76. As shown, the controller 76 has a number of physical and logical components, including a central processing unit (“CPU”) 204, random access memory (“RAM”) 208, an input/output (“I/O”) interface 212, a network interface 216, non-volatile storage 220, and a local bus 224 enabling the CPU 204 to communicate with the other components. The CPU 204 can include one or more processors and executes at least an operating system, and a vehicle conveyor operation program. RAM 208 provides relatively responsive volatile storage to the CPU 204. The I/O interface 212 allows for input to be received from one or more devices, such as a keyboard, a mouse, etc. In addition, the I/O interface 212 is in communication with the high mount detector structure 84 and the low mount detector structure 88 to receive sensor data from the array of sensors 120. Further, the I/O interface 212 is in communication with the drive unit 72 to control operation of the vehicle conveyor. Connections with the array of sensors 120 and the drive unit 72 can be wired or wireless, and are wired in this embodiment. Non-volatile storage 216 stores the operating system and programs, including computer-executable instructions for implementing the vehicle conveyor operation program. During operation of controller 76, the operating system, the programs and any corresponding data may be retrieved from the non-volatile storage 216 and placed in RAM 208 to facilitate execution.

Referring to FIG. 1, the controller 76 uses sensor data from the high mount detector structure 84 and the low mount detector structure 88 to determine if a leading vehicle towards the dismounting end 68 of the vehicle conveyor is impeding safe progress of a successive vehicle being conveyed by the endless belts 52. When a vehicle's front wheels reach the dismounting end 68 of the endless belts 52, the driver is urged to drive their vehicle off of the endless belts 52 and out of the vehicle wash 20. If the vehicle is not moved from the dismounting end 68 of the endless belts, the successive vehicle may contact the leading vehicle, potentially causing damage to the vehicles and personal injury of their occupants. In order to prevent such contact, the controller 76 terminates operation of the vehicle conveyor system 48 when a distance between the leading vehicle and a successive vehicle is below a threshold.

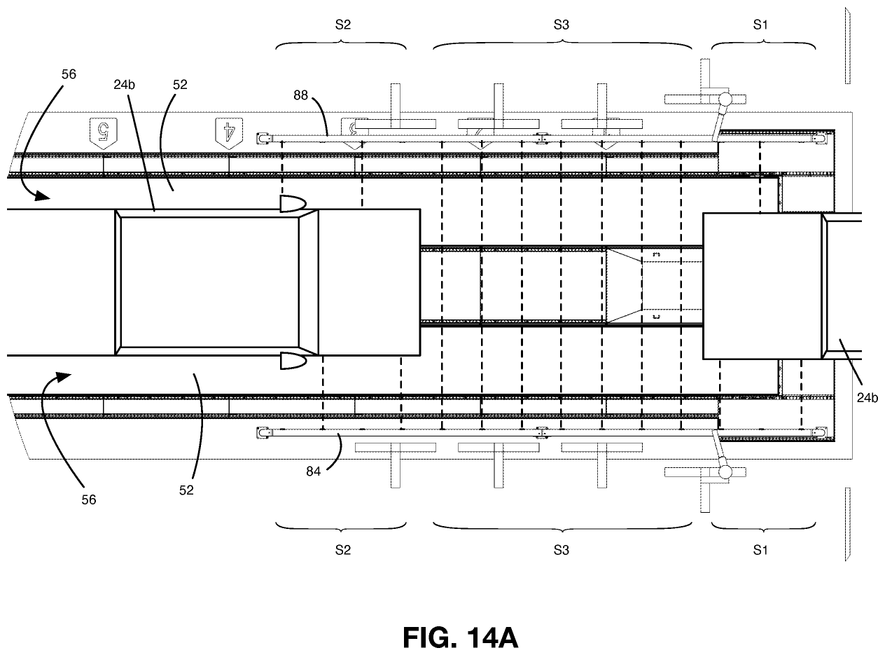

The method 300 for controlling the vehicle conveyor system 48 via the controller 76 will now be discussed with reference to FIGS. 1 to 11 and 13. The method 100 commences with the commencement of operation of the endless belts 52 (310). The controller 76 directs the drive unit 72 to commence driving the endless belts 52. The drive unit 72 begins to drive the endless belts 52, slowly accelerating until a desired operation speed is reached. The high mount detector structure 84 and the low mount detector structure 88 are powered, and sensor data is generated by the array of sensors 120. The sensor data can be binary (that is, beam detected or no beam detected), or can indicate a level of light detected so that the controller 76 can make a determination as to whether or not it is believed that the beam is detected.

The controller 76 analyzes the sensor data received from the array of sensors 120 to determine the spacing between vehicles (330). The spacing, or distance along the longitudinal axis LA of the vehicle conveyor, between vehicles is determined by identifying consecutive sensors 120 deemed to be detecting beams; that is, corresponding to unobstructed beams passing between vehicles. The number of consecutive sensor 120 detecting beams identifies the minimum distance between the vehicles. For example, if five consecutive sensors detect beams, then the distance between vehicles is between 56 inches (the spacing between five consecutive sensors) and 70 inches (the spacing between six consecutive sensors).

Referring to FIGS. 1, 11, and 14A, the vehicle conveyor system 48 is shown having a leading vehicle 24a positioned towards the dismounting end of the endless belts 52. A successive vehicle 24b is shown positioned behind the leading vehicle 24a by a distance. The leading vehicle 24a obstructs the beams from the last three beam transmitters 116l to 116n. As a result, a continuous set S1 of sensors 120l to 120n generate sensor data that indicates that no beam is detected; that is, that an absence of the beam is detected. The successive vehicle 24b obstructs the beams from the first four beam transmitters 116a to 116d positioned along the high mount and low mount detector structures 84, 88. As a result, a continuous set S2 of sensors 120a to 120d generate sensor data that indicates that no beam is detected; that is, that an absence of the beam is detected. The beams of beam transmitters 116e to 116k are unobstructed and received by a corresponding continuous set S3 of sensors 120e to 120k, which generate sensor data that indicates that a beam is detected; that is, that the beam is registered. As there is fourteen inches between adjacent beam transmitters 116 and sensors 120 along the detector bars 96, there is at least 84 inches between the vehicles 24a, 24b.

The controller receives the sensor data and determines that consecutive sensors 120e to 120k are deemed to be detecting beams.

The controller determines if the spacing between vehicles is below a threshold (340). The vehicle conveyor operation program is configured with a threshold of four sensors 120. As the spacing between adjacent sensors 120 is 14 inches, a sequence of four sensors 120 represents a distance of at least 42 inches. It has been determined that a sequence of four consecutive sensors 120 best corresponds to a minimum distance to be maintained between vehicles on the vehicle conveyor to inhibit contact between the vehicles.

If the controller determines at 340 that the spacing between vehicles is greater than or equal to the threshold, the controller determines the motion of the vehicles from the sensors receiving beams (350). The motion of the vehicles can be inferred by changes in the spacing between the vehicles as indicated by the number of sequential detected beams. If a leading vehicle moves forward relative to the vehicle conveyor while a trailing vehicle remains motionless relative to the vehicle conveyor, the spacing between the vehicles will increase, and, if sufficiently significant, the increase in spacing will be reflected by an increase in the number of detected beams between sequences of obstructed beams. Similarly, if the leading vehicle moves backward relative to the vehicle conveyor (i.e., reverses) and/or the trailing vehicle moves forward relative to the vehicle conveyor, the spacing between the vehicles will decrease, and, if sufficiently significant, the decrease in spacing will be reflected by a decrease in the number of detected beams between sequences of obstructed beams. The controller may be configured to tolerate changes in the length of sequences of detected beams by one to compensate for scenarios when the spacing between the vehicles is not an integral multiple of 14 inches.

The controller then determines if the motion of the vehicles is deemed acceptable (360). The controller analyzes the sequences of obstructed beams representing vehicles and sequences of detected beams representing spaces between the vehicles to determine if (a) one of the vehicles is traveling in reverse, or (b) one of the vehicles, apart from a vehicle that is at least partially off of the vehicle conveyor, is traveling forward relative to the vehicle conveyor. If a vehicle is reversing or moving forward relative to the vehicle conveyor, there is a possibility that the vehicle could contact another vehicle on the vehicle conveyor. If a vehicle is positioned towards the dismounting end of the vehicle conveyor with its front wheels on the ground surface in front of the vehicle conveyor and is deemed to be moving backwards relative to the movement of the vehicle conveyor, the vehicle may be in park or in gear so that the front wheels are locked, inhibiting forward movement of the vehicle. This poses a risk of contact with a subsequent vehicle being conveyed. Further, there is a risk that the vehicle conveyor can be damaged as a result of urging a vehicle while the vehicle resists further movement forward. As a result, it can be desirable to stop movement of the vehicle conveyor until this issue is rectified. A threshold degree of movement relative to the vehicle conveyor can be utilized to avoid termination of operation of the vehicle conveyor where a vehicle operator temporarily commences operation of a vehicle on the vehicle conveyor, but ceases quickly thereafter. For example, the threshold degree of movement can be one sensor (approximately fourteen inches) in either direction relative to the vehicle conveyor. Another threshold degree of movement could be another relative distance variation range, or can be any other suitable means for detecting motion that is deemed risking contact between vehicles.

An exception is when a vehicle positioned at the end of the vehicle conveyor accelerates faster than the movement of the endless belt while dismounting from the vehicle conveyor. As it is unlikely that modification of the operation of the vehicle conveyor will reduce any risk of contact between vehicles, no modification of the operation of the vehicle conveyor is made. Where a vehicle positioned at least partially off of the vehicle conveyor at the dismounting end and has their parking brakes engaged, or is in gear, but hasn't driven away, the vehicle will be deemed to be traveling in reverse relative to the motion of the vehicle conveyor.

If the determined motion of the vehicles detected by the controller relative to the motion of the vehicle conveyor is deemed acceptable (i.e., within the threshold degree of relative movement), the controller continues to monitor the sensor data received from the sensors 120 at 320.

If, instead, the controller determines that the spacing between vehicles is less than the threshold at 340, or determines that the motion of one or more of the vehicles detected by the controller relative to the speed of the vehicle conveyor is unacceptable at 360 (based on a change in the spacing between vehicles), the controller terminates operation of the vehicle conveyor (370). The controller directs the drive unit 72 to safely decelerate the endless belts 52 to stop forward movement of the vehicles on the endless belts 52. In particular, the controller decelerates the endless belts 52 over 30 inches. It is contemplated that decelerating movement of the vehicle conveyor can be performed over a shorter or longer time period, distance, etc. If the number of consecutive sensors 120 detecting beams is less than three, the controller can be configured to decelerate the endless belts 52 more rapidly.

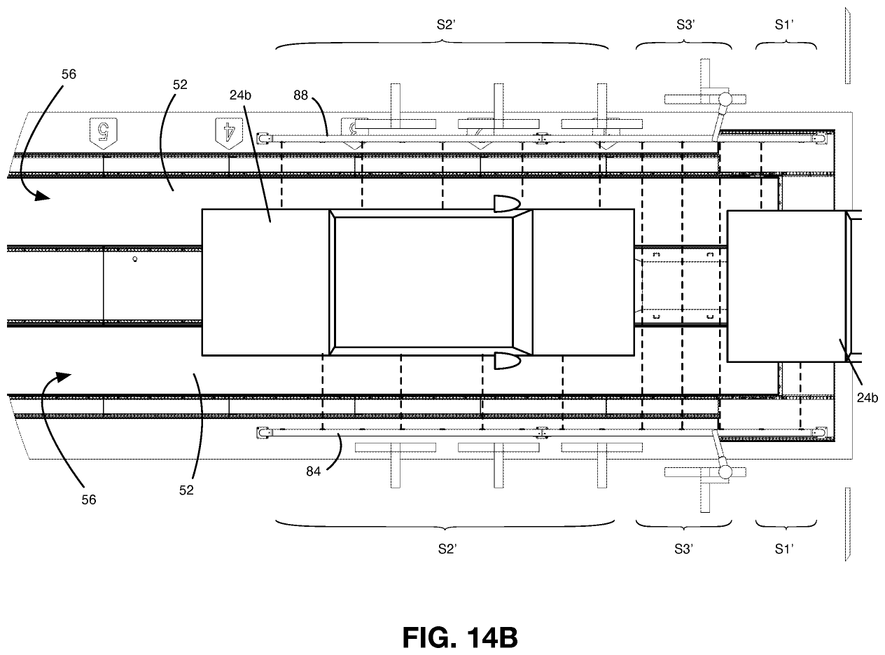

FIG. 14B shows the vehicle conveyor system 48 having a leading vehicle 24a positioned towards the dismounting end of the endless belts 52, and a successive vehicle 24b positioned behind the leading vehicle 24a by a smaller distance than in FIG. 14A. The leading vehicle 24a obstructs the beams from the last two beam transmitters 116m to 116n. As a result, a continuous set S1′ of sensors 120m to 120n generate sensor data that indicates that no beam is detected. The successive vehicle 24b obstructs the beams from the first nine beam transmitters 116a to 116i positioned along the high mount and low mount detector structures 84, 88. As a result, a continuous set S2′ of sensors 120a to 120i generate sensor data that indicates that no beam is detected. The beams from beam transmitters 116j to 116l are unobstructed and received by a corresponding continuous set S3′ of sensors 120j to 120l, which generate sensor data that indicates that a beam is detected. The controller in this scenario determines at 340 that the number of consecutive sensors 120 is below the threshold of four, and subsequently terminates operation of the vehicle conveyor system 48 at 350. Even before the vehicles 24a, 24b arrive at their respective positions shown in FIG. 14B, the controller can determine that the leading vehicle 24a is traveling in reverse relative to the movement of the endless belts 52 and outside the threshold degree of relative movement at 360 and terminate operation of the endless belts 52 at 370.

It is contemplated that the controller can recommence operation of the vehicle conveyor upon a satisfaction of a condition. For example, the computer-executable instructions executed by the controller can cause the controller to recommence operation of the vehicle conveyor once the threshold spacing between adjacent vehicles is re-established. In another example, the computer-executable instructions executed by the controller can cause the controller to recommence operation of the vehicle conveyor once movement of a vehicle relative to the vehicle conveyor is within the threshold degree of relative movement for a specified period, such as two or three seconds.

In another embodiment, the controller compares the motion of the vehicles on the vehicle conveyor to the speed of motion of the vehicle conveyor using the “movement” of the first and/or last of the obstructed beams in an obstructed sequence representing a vehicle across the sensor array. The controller can track the timing of the obstructing or re-detecting of beams along a front or a tail of a sequence of obstructed beams to determine how fast a vehicle is moving. Based on the projected positions of vehicles using this information, the controller can estimate the distance between vehicles. Further, the spacing threshold between vehicles and the threshold degree of movement used at 360 can be expressed in actual distances (e.g., 45 inches and 10 inches respectively) in either direction relative to the vehicle conveyor. Another threshold degree of movement could be another relative distance variation range, or can be any other suitable means for detecting motion that is deemed risking contact between vehicles.

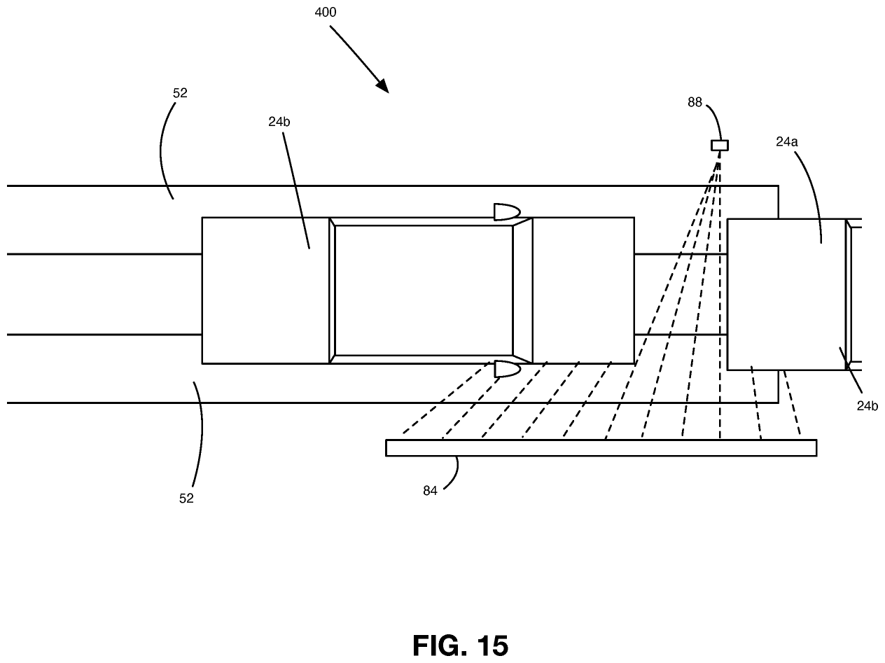

FIG. 15 shows a vehicle conveyor system 400 in accordance with another embodiment. The vehicle conveyor system includes a system for controlling a vehicle conveyor having a beam transmitter array 404 and a sensor 408. The beam transmitter array 404 is positioned on one lateral side of a vehicle conveyor including a pair of endless belts 52, and the sensor 408 is positioned on an opposite side of the endless belts 52. Each of the individual beam transmitters of the beam transmitter array 404 is configured to direct a beam at the sensor 408. Further, each of the beam transmitters of the beam transmitter array 404 can be configured to transmit a beam having a unique characteristic. For example, the beam transmitters can be selected to transmit beams of differing wavelengths, or can beam pulses at different frequencies or patterns. The sensor 408 can generate sensor data that is then parsed by a controller operably connected to the sensor 408 to identify the beams received.

In turn, the controller can determine which beams are obstructed. Additionally, the controller can reference a spatial mapping of the beam transmitters to estimate the spacing between the vehicles 24a and 24b.

Other configurations of the array of beam transmitters and at least one sensor will occur to one having ordinary skill in the art.

While laser beam transmitters and optical sensors are employed in the above-described embodiment, other types of optical and electromagnetic beams can be employed. For example, infrared and other wavelengths can be utilized.

In other embodiments, the controller can analyze vehicle velocities to identify risks of contact. For example, if the sensors towards the end of the sensor array detect that a vehicle positioned at the end of the vehicle conveyor is travelling in a reverse direction, the controller can make a determination to terminate operation of the vehicle conveyor system, even if the spacing between the reversing vehicle and a successive vehicle is at or above a threshold distance.

The array of beam transmitters and sensors can be provided via individual beam transmitter modules and sensor modules, or smaller groups of beam transmitters and sensors. The beam transmitters and/or groups thereof can be mounted on existing structures.

Computer-executable instructions for vehicle conveyor operation program on a controller can be provided separately from the controller, for example, on a computer-readable medium (such as, for example, an optical disk, a hard disk, a USB drive or a media card) or by making them available for downloading over a communications network, such as the Internet.

While the controller is shown as a single physical computing device, it will be appreciated that the controller can include two or more physical computing devices in communication with each other. Accordingly, while the embodiment shows the various components of the controller residing on the same physical computing device, those skilled in the art will appreciate that the components can reside on separate physical computing devices.

The controller can maintain a log of the sensor data and its operation, together with image data from the video camera, so that any incidents can be analyzed to determine a cause.

Although specific advantages have been enumerated above, various embodiments may include some, none, or all of the enumerated advantages.

Persons skilled in the art will appreciate that there are yet more alternative implementations and modifications possible, and that the above examples are only illustrations of one or more implementations. The scope, therefore, is only to be limited by the claims appended hereto and any amendments made thereto.

### LIST OF REFERENCE NUMERALS

20 vehicle wash
24, 24a, 24b vehicle
28 washing apparatuses
32 rinsing apparatuses
36 drying apparatuses
40a, 40b rotating wash brushes
44 rinsing bar
48 vehicle conveyor system
52 endless belt
56 outer surface
60 drying vent bar
64 mounting end
68 dismounting end
72 drive unit
76 controller
80 vehicle sensor system
84 high mount detector structure
88 low mount detector structure
90 horizontal mounting surface
91 video camera
92, 92a, 92b support post
96, 96a, 96b detector bar
100 mounting bracket
104 vertical mounting bracket
108 aperture
112 bushing
116, 116a to 116n beam transmitter
120, 120a to 120n sensor
124 support post
128 vent
132 pit wall
204 CPU
208 RAM
212 I/O interface
216 non-volatile storage
220 local bus
300 method for controlling vehicle conveyor system
310 commence operation of vehicle conveyor
320 receive sensor data
330 determine spacing between vehicles
340 spacing below threshold?
350 determine motion of vehicles from sensors receiving beams
360 is motion deemed acceptable?
370 terminate operation of vehicle conveyor
400 vehicle conveyor system
404 beam transmitter array
408 sensor
LA longitudinal axis
UBD upper belt direction
VP vehicle path
S1, S1′ set
S2, S2′ set
S3, S3′ set

What is claimed is:

1. A system for controlling a vehicle conveyor, comprising:
an array of beam transmitters, each of the array of beam transmitters being positionable to transmit a beam towards a vehicle path through which a vehicle is expected to travel;
at least one sensor, each of the at least one sensor being positionable to receive the beam from at least one of the array of beam transmitters when the beam is unobstructed and generate sensor data;
a storage storing computer-executable instructions; and
a controller in communication with the storage and connected to the at least one sensor, the controller, when executing the computer-executable instructions, being configured to control operation of the vehicle conveyor at least partially based on the sensor data.

2. The system of claim 1, wherein the at least one sensor includes an array of sensors, each of the array of sensors being aligned to receive a transmitted beam from a corresponding one of the array of beam transmitters with which the sensor and the corresponding one of the array of beam transmitters forms a transmitter-sensor pair.

3. The system of claim 2, wherein the array of beam transmitters and the array of sensors are arranged along at least one first lateral structure and at least one second lateral structure, the at least one first lateral structure and the at least one second lateral structure being positionable along lateral sides of the vehicle path.

4. The system of claim 3, wherein the array of sensors and the array of beam transmitters are positioned along pivotable members of the at least one first lateral structure and the at least one second lateral structure to enable alignment of the array of sensors and the beams from the array of beam transmitters when the at least one first lateral structure and the at least one second lateral structure are positioned along the lateral sides of the vehicle path.

5. The system of claim 4, wherein the at least one first lateral structure and the at least one second lateral structure are configured to be mounted on a horizontal surface, and wherein the array of sensors and/or the array of beam transmitters positioned along the pivotable members of the at least one first lateral structure are configured to be further elevated from the horizontal surface than the array of sensors and/or the array of beam transmitters positioned along the pivotable members of the at least one second lateral structure.

6. The system of claim 3, wherein one of the beam transmitter and the sensor of each of the transmitter-sensor pairs are regularly spaced along the at least one first lateral structure, and wherein another of the beam transmitter and the sensor of each of the transmitter-sensor pairs are regularly spaced along the at least one second lateral structure.

7. The system of claim 6, wherein the sensors of each adjacent transmitter-sensor pair are on alternating ones of the at least one first lateral structure and the at least one second lateral structure.

8. The system of claim 6, wherein the controller, when executing the computer-executable instructions, monitors the sensor data to determine a spacing between consecutive vehicles, and terminates operation of the vehicle conveyor if the spacing is lower than a threshold.

9. The system of claim 8, wherein the spacing between consecutive vehicles is measured by a number of the sensors in a first continuous set of the sensors in the array that are registering a beam, the first continuous set of the sensors separating a second continuous set of the sensors in the array and a third continuous set of the sensors in the array, the second set of the sensors and the third set of the sensors detecting an absence of a beam, and wherein the threshold is defined as a desired minimum number of sensors between the vehicles.

10. The system of claim 9, wherein the controller, when executing the computer-executable instructions, monitors the number of the sensors in the first continuous set, and terminates operation of the vehicle conveyor if the number of the sensors in the first continuous set changes by more than a threshold number of the sensors.

11. The system of claim 7, wherein the controller, when executing the computer-executable instructions, monitors the sensor data to determine a spacing between consecutive vehicles, and terminates operation of the vehicle conveyor if the spacing is lower than a threshold.

12. The system of claim 11, wherein the spacing between consecutive vehicles is measured by a number of the sensors in a first continuous set of the sensors in the array that are registering a beam, the first continuous set of the sensors separating a second continuous set of the sensors in the array and a third continuous set of the sensors in the array, the second set of the sensors and the third set of the sensors detecting an absence of a beam, and wherein the threshold is defined as a desired minimum number of sensors between the vehicles.

13. The system of claim 12, wherein the controller, when executing the computer-executable instructions, monitors the number of the sensors in the first continuous set, and terminates operation of the vehicle conveyor if the number of the sensors in the first continuous set changes by more than a threshold number of the sensors.

14. The system of claim 1, wherein the beam transmitters are optical beam transmitters.

15. A vehicle wash having a system for controlling a vehicle conveyor, comprising:
a vehicle conveyor configured to move a vehicle along a vehicle path;
an array of beam transmitters, each of the array of beam transmitters being positionable to transmit a beam towards the vehicle path;
at least one sensor, each of the at least one sensor being positionable to receive the beam from at least one of the array of beam transmitters when the beam is unobstructed and generate sensor data;
a storage storing computer-executable instructions; and
a controller in communication with the storage and connected to the at least one sensor, the controller, when executing the computer-executable instructions, being configured to control operation of the vehicle conveyor at least partially based on the sensor data.

16. The vehicle wash of claim 15, wherein the at least one sensor includes an array of sensors, each of the array of sensors being aligned to receive a transmitted beam from a corresponding one of the array of beam transmitters with which the sensor and the corresponding one of the array of beam transmitters forms a transmitter-sensor pair.

17. The vehicle of claim 16, wherein the array of beam transmitters and the array of sensors are arranged along at least one first lateral structure and at least one second lateral structure, the at least one first lateral structure and the at least one second lateral structure being positionable along lateral sides of the vehicle path.

18. The vehicle wash of claim 17, wherein the array of sensors and the array of beam transmitters are positioned along pivotable members of the at least one first lateral structure and the at least one second lateral structure to enable alignment of the array of sensors and the beams from the array of beam transmitters when the at least one first lateral structure and the at least one second lateral structure are positioned along the lateral sides of the vehicle path.

19. The vehicle wash of claim 18, wherein the at least one first lateral structure and the at least one second lateral structure are configured to be mounted on a horizontal surface, and wherein the array of sensors and/or the array of beam transmitters positioned along the pivotable members of the at least one first lateral structure are configured to be further elevated from the horizontal surface than the array of sensors and/or the array of beam transmitters positioned along the pivotable members of the at least one second lateral structure.

20. The vehicle wash of claim 17, wherein one of the beam transmitter and the sensor of each of the transmitter-sensor pairs are regularly spaced along the at least one first lateral structure, and wherein another of the beam transmitter and the sensor of each of the transmitter-sensor pairs are regularly spaced along the at least one second lateral structure.

21. The vehicle wash of claim 20, wherein the sensors of each adjacent transmitter-sensor pair are on alternating ones of the at least one first lateral structure and the at least one second lateral structure.

22. The vehicle wash of claim 20, wherein the controller, when executing the computer-executable instructions, monitors the sensor data to determine a spacing between consecutive vehicles, and terminates operation of the vehicle conveyor if the spacing is lower than a threshold.

23. The vehicle wash of claim 22, wherein the spacing between consecutive vehicles is measured by a number of the sensors in a first continuous set of the sensors in the array that are registering a beam, the first continuous set of the sensors separating a second continuous set of the sensors in the array and a third continuous set of the sensors in the array, the second set of the sensors and the third set of the sensors detecting an absence of a beam, and wherein the threshold is defined as a desired minimum number of sensors between the vehicles.

24. The vehicle wash of claim 23, wherein the controller, when executing the computer-executable instructions, monitors the number of the sensors in the first continuous set, and terminates operation of the vehicle conveyor if the number of the sensors in the first continuous set changes by more than a threshold number of the sensors.

25. The vehicle wash of claim 21, wherein the controller, when executing the computer-executable instructions, monitors the sensor data to determine a spacing between consecutive vehicles, and terminates operation of the vehicle conveyor if the spacing is lower than a threshold.

26. The vehicle wash of claim 25, wherein the spacing between consecutive vehicles is measured by a number of the sensors in a first continuous set of the sensors in the array that are registering a beam, the first continuous set of the sensors separating a second continuous set of the sensors in the array and a third continuous set of the sensors in the array, the second set of the sensors and the third set of the sensors detecting an absence of a beam, and wherein the threshold is defined as a desired minimum number of sensors between the vehicles.

27. The vehicle wash of claim 26, wherein the controller, when executing the computer-executable instructions, monitors the number of the sensors in the first continuous set, and terminates operation of the vehicle conveyor if the number of the sensors in the first continuous set changes by more than a threshold number of the sensors.

28. The vehicle wash of claim 15, wherein the beam transmitters are optical beam transmitters.

29. The vehicle wash of claim 15, wherein the array of beam transmitters and the at least one sensor are positioned towards a dismounting end of the vehicle conveyor.
